(19) United States
(12) Patent Application Publication
(10) Pub. No.: US 2023/0353831 A1
(43) Pub. Date: Nov. 2, 2023

(54) CONTENT DELIVERY SYSTEM

(71) Applicant: Avex Technologies Inc., Minato-ku (JP)

(72) Inventors: Yutaka KINO, Minato-ku (JP); Yoshiki KASHITANI, Minato-ku (JP); Asahi IWANAGA, Minato-ku (JP)

(21) Appl. No.: 18/006,516

(22) PCT Filed: Jul. 21, 2021
(86) PCT No.: PCT/JP2021/027423

§ 371 Date: Jan. 23, 2023

(30) Foreign Application Priority Data
Jul. 21, 2020 (JP) 2020-124737

(51) Int. Cl. H04N 21/4788; H04N 21/239; H04N 21/258; H04N 21/27; G06Q 20/14

(52) U.S. Cl. CPC H04N 21/4788; H04N 21/239; H04N 21/258; H04N 21/27; G06Q 20/14

(57) ABSTRACT

[Problem] To enable a gift from a viewer provided to a provider of content. [Solution] A content distribution system comprising: a gift receiving unit that receives gifts from multiple viewers when distributing a content; a gift displaying unit that displays the received gift and information indicating the viewer in order of values of the gifts; a value varying unit that varies the value of the gift; wherein: the gift receiving unit adds to the value of the gift when receiving additional provision of the gift.

### TECHNICAL FIELD

The present invention relates to a content distribution system.

### BACKGROUND ART

There are known systems for providing gifts such as celebrations and gifts to content performers (see Patent Literature 1).

### CITATION LIST

### Patent Literature

### [PTL 1]

Japanese Patent Application Publication No. 2012-120098

### SUMMARY OF INVENTION

### Technical Problem

There is a need for viewers to be aware that they themselves are gift providers.

The present invention has been made in light of this background, and is intended to provide a technology capable of providing a gift from a viewer to a provider of content.

### Solution to Problem

The main feature of the present invention is a content distribution system comprising: a gift receiving unit that receives gifts from multiple viewers when distributing a content; a gift displaying unit that displays the received gift and information indicating the viewer in order of values of the gifts; a value varying unit that varies the value of the gift; wherein: the gift receiving unit adds to the value of the gift when receiving additional provision of the gift.

The other problems disclosed in the present application and the method for solving them are clarified in the sections and drawings of the embodiments of the invention.

### Advantageous Effects of Invention

According to the present invention, a gift from a viewer can be provided to a provider of content.

### BRIEF DESCRIPTION OF DRAWINGS

FIG. 1 is a diagram illustrating an example of an overall configuration of the content distribution system according to an embodiment of the present invention.

FIG. 2 is a diagram illustrating a hardware configuration example of the server 2.

FIG. 3 is a diagram illustrating an example of a software configuration of the server 2.

FIG. 4 is a diagram illustrating an example of a display screen of a content distribution image.

FIG. 5 is a diagram illustrating the operation of the content distribution system according to the present embodiment.

### DETAILED DESCRIPTION OF THE EMBODIMENTS

### <Outline of the Invention>

The following is a list and description of the contents of the embodiments of the invention. The invention comprises, for example, the followings.

### [Item 1]

A content distribution system comprising:
a gift receiving unit that receives gifts from multiple viewers when distributing a content;
a gift displaying unit that displays the received gift and information indicating the viewer in order of values of the gifts;
a value varying unit that varies the value of the gift;
wherein:
the gift receiving unit adds to the value of the gift when receiving additional provision of the gift.

### [Item 2]

The content distribution system according to item 1, wherein:
the gift is tipping and includes an amount of money, and
   the value varying unit decreases the amount of money over time.

### [Item 3]

The content distribution system according to item 2, further comprising:
a payment processing unit that pays a fee to a distributor of the content in accordance with the decreased amount.

### [Item 4]

The content distribution unit according to item 2, wherein:
the gift displaying unit clears the gift and the information indicating the viewer when the value no longer exists.

### <System Overview>

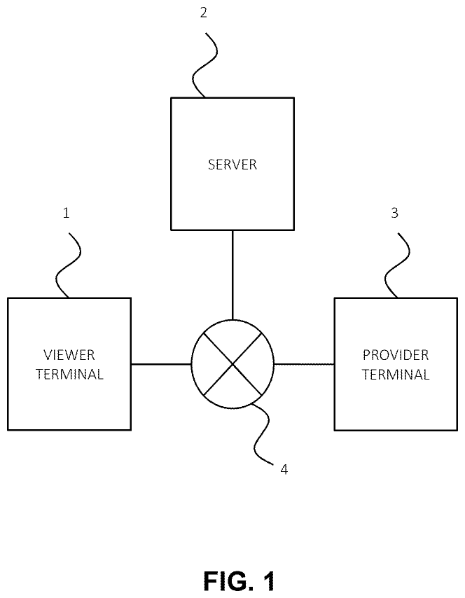

FIG. 1 is a diagram illustrating an example of an overall configuration of the content distribution system according to an embodiment of the present invention. The content distribution system of the present embodiment includes a server 2. The server 2 is communicatively connected to each of a viewer terminal 1 and a distributor terminal 3 via a communication network 4. The communication network 4 is, for example, the Internet and may be constructed by a public telephone network, a cellular telephone network, a wireless communication line, an Ethernet (registered trademark), or the like.

In this embodiment, it is assumed that the content is a video, and the server 2 distributes the content of the video to the viewer terminal 1 by streaming.

The distributor terminal 3 is a computer operated by the distributor who distributes the content. The distributor terminal 3 may be, for example, a smartphone, a tablet computer, a personal computer, or the like. The distributor can register the content on the server 2 from the distributor terminal 3.

The viewer terminal 1 is a computer operated by a viewer of the content. The viewer terminal 1 may be, for example, a smartphone, a tablet computer, a personal computer, or the like. The viewer can receive the content to the viewer terminal 1 and watch the content such as the video and audio output from the viewer terminal 1 by operating the viewer terminal 1 and accessing the server 2.

The server 2 is a computer that distributes content. The server 2 may be a general-purpose computer, such as a workstation or personal computer, or may be logically implemented by cloud computing.

### <Server 2>

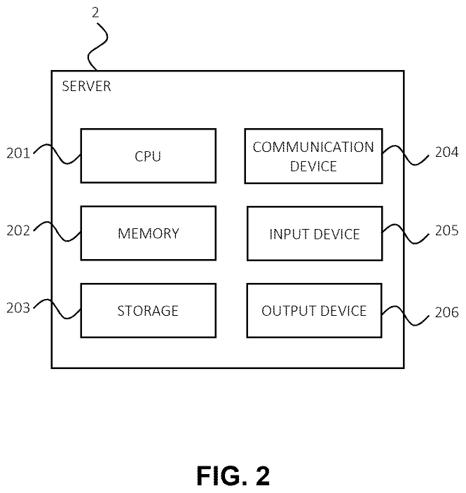

FIG. 2 is a diagram illustrating an example of a hardware configuration of the server 2. The illustrated configuration is exemplary and may have other configurations. The server 2 includes a CPU 201, a memory 202, a storage device 203, a communication interface 204, an input device 205, and an output device 206. The storage device 203 may be, for example, a hard disk drive, a solid state drive, a flash memory, or the like, for storing various types of data or programs. The communication interface 204 is an interface for connecting to the communication network 3, such as an adapter for connecting to an Ethernet (registered trademark), a modem for connecting to a public telephone network, a wireless communication device for performing wireless communication, a USB (Universal Serial Bus) connector for serial communication, or an RS232C connector. The input device 205 may be, for example, a keyboard or mouse, a touch panel, a button, a microphone, or the like, for inputting data. The output device 206 may be, for example, a display, a printer, a speaker, or the like, for outputting data. The functional portions of the server 2, which will be described later, can be realized by reading out a program stored in the storage device into memory and executing the program.

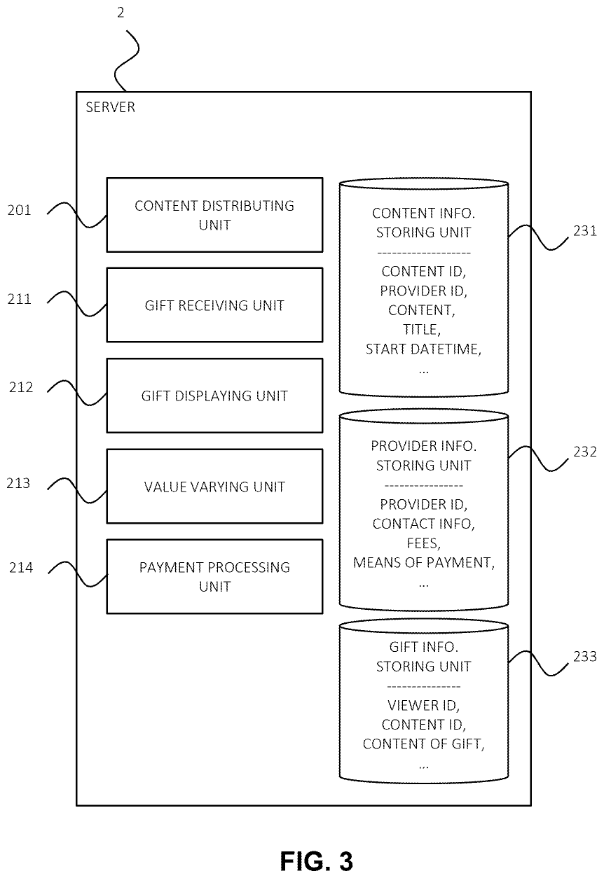

FIG. 3 is a diagram illustrating an example of the software configuration of the server 2.

The server 2 may comprise a content information storing unit 231 that stores information related to the content (hereinafter referred to as the content information), a provider information storing unit 232 that stores information about the provider (hereinafter referred to as the provider information), a gift information storing unit 233 that stores information on a gift from a viewer to a content provider (hereinafter referred to as gift information), a content distributing unit 210 that distributes the content, a gift receiving unit 211 that receives gifts from multiple viewers when distributing content, a gift displaying unit 212 which displays information indicating the viewer who provided the received gift and gift in order of the value of the gift, a value varying unit 213 that changes the value of the gift, a payment processing unit 214 that pays fees to the content distributor according to the varied value of the gift.

The content information includes the provider ID that indicates a provider of the content, a content (in this embodiment, video data is assumed), a title, date and time of the content distribution start, etc. in relation to the content ID that identifies the content. The content information can include various types of meta-information related to the content. The content may be static data, such as video or audio data, or, in the case of dynamically streaming real-time data, such as live performances, the data required for streaming distribution (e.g., the IP address or URL of the computer that transmits the photographed data at the live venue, etc.).

The content distributing unit 210 distributes the content based on the content information. The distribution process by the content distributing unit 210 may employ a technology used in a general video distribution service. The content distributing unit 210 may, for example, read video data included in the content information on which the delivery start date and time has arrived and transmit the video data to the plurality of viewer terminals 1. Further, the content distributing unit 210 may be configured to relay the streaming data from the live venue, for example, and transmit the streaming data to the plurality of viewer terminals 1.

The provider information includes the contact information of the provider (that may be, for example, an email address and a chat service ID), fees for the provider, and means of payment for the provider, in relation to the provider's ID that indicates the provider. In this embodiment, the fee is the amount of tipping (may be an amount or a point). In this embodiment, as will be described later, the amount of tipping is managed for each viewer, the amount of tipping is reduced by a certain period of time, and the reduced amount (fees may be subtracted) is added to the fees of the provider information. The means of payment may be, for example, a means of payment in a statutory currency, such as a bank account, or may be a user ID or point account number that manages the points of the company or another company.

The content of the gift provided by the viewer to the content is managed in the gift information in association with the viewer ID which identifies the viewer and the content ID which identifies the content. The value of the gift is set in the content of the gift. In this embodiment, the gift is assumed to be a tipping and the amount of the tipping is set to the content of the gift as the value. The gift content may include the type of gift. If multiple gifts are provided by the viewer, the gift content may control the total value of the gift provided by the viewer (the amount of the gift) or may control the history of the value of the gift per offer.

The gift receiving unit 211 receives a virtual gift. The gift receiving unit 211 may receive, for example, the amount of money thrown as a gift from a viewer. For example, when a chat service for displaying a comment on the content is provided, the gift reception unit 211 may accept a chat including an amount of tipping as a gift.

In addition, the gift receiving unit 211 may add the value of the additional gift received to the value of the first gift provided when multiple gifts are received from the same viewer. In this embodiment, the gift receiving unit 211 may add (or add to the gift history) the value of the received gift (the amount of tipping) to the gift in the gift information corresponding to the viewer.

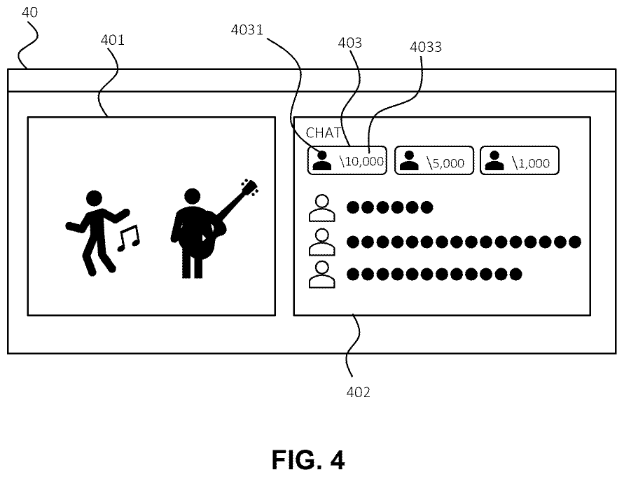

The gift displaying unit 212 may display the amount of tipping together with the information indicating the viewer. FIG. 4 is a diagram illustrating an example of the display screen of the content distribution image. The screen 40 includes a display portion 401 of the content and a display field 402 of comments submitted by the viewer, and a gift 403 is displayed at the top of the display field 402 of the comment. The gift 403 includes an icon 4031 indicating the viewer who provided the money and the tipping amount 4033. The gifts 403 are arranged in the descending order of the tipping amount 4033, as described above. The gift displaying unit 212 may prevent a certain number or more of gifts 403 from being displayed on the screen 40.

As described above, the tipping amount 4033 is reduced over time, and the gift displaying unit 212 may sort the gift 403 from time to time in the descending order of the tipping amount by the viewer 4033 (the remaining amount of the gift provided by the viewer as indicated by the gift information).

The gift displaying unit 212 may erase the gift 403 (the display of information indicating the gift and viewer) when the value of the gift 403 (the tipping amount 4033 per viewer, that is, the amount of gift represented by the content of the gift in the gift information corresponding to the viewer) has no longer exist.

The value varying unit 213 can reduce the value of the gift over time. The value varying unit 213 may deduct a certain amount, such as 10 yen, 100 yen, 500 yen, and 1000 yen, from the content of the gift in the gift information (the tipping amount) every time a predetermined time elapses, such as 1 second, 5 seconds, and 10 seconds. If the total amount of the gift is managed in the content of gift in the gift information, the amount may be deducted from the gift, and if the history is managed in the content of gift in the gift information, it may be added to the gift content as a gift of negative value. The value varying unit 213 may be added to the fees of the provider information in accordance with the value (amount) deducted from the balance of the gift content (balance of the tipping amount), which may be the value (amount) as is, or the amount of deduction from which the commission is deducted, or the amount of deduction as a result of passing the deduction to any function.

In this embodiment, the amount obtained by subtracting the balance of the tipping is added to the fees of the provider information, so that the payment processing unit 214 can perform the payment processing according to the fees of the provider information. The payment processing unit 214 may process the payment of the amount corresponding to the fees of the provider information based on the payment information of the provider information (which may be the amount of fees per se, which may be the amount of fees from which the commission is deducted, or which may be the result of giving amount of fees to some function). With regard to payment processing, a method used in general settlement services and point services can be adopted.

### <Operation>

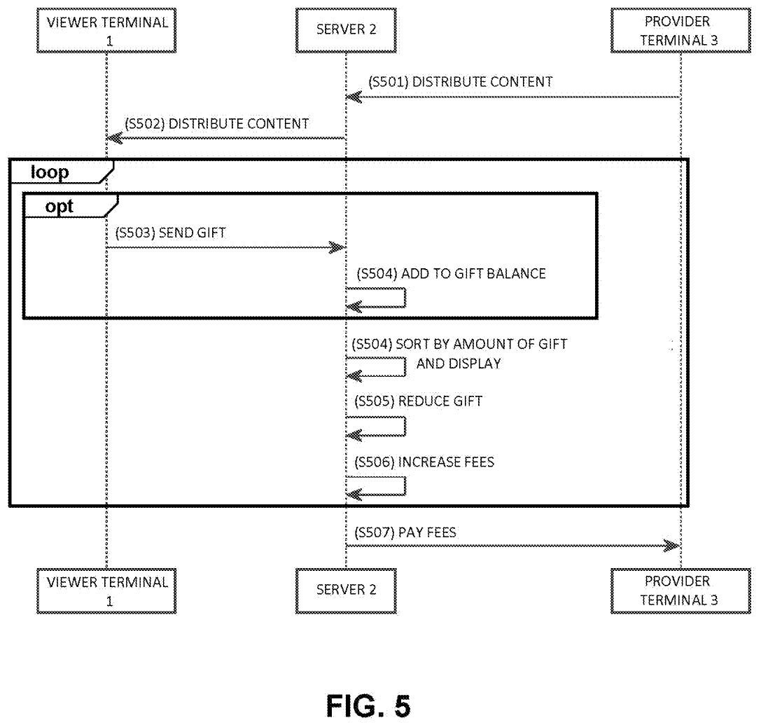

FIG. 5 is a diagram illustrating the operation of the content distribution system according to the present embodiment.

The content is transmitted from the provider terminal 3 to the server 2 (S501), and the content is distributed from the server 2 to the plurality of viewer terminals 1 (S502).

When a gift for content is sent from the viewer terminal 1 to the server 2 (S503), the gift information is created when the first gift is provided, and when the second or subsequent gift is provided, the amount is added to the balance of the gift information (S504). The server 2 displays a predetermined number of viewers in descending order of the gift balance (S504).

The server 2 reduces the gift balance (S505) on an hourly basis and adds it to the provider's fees (S506).

The server 2 pays the fees to the provider at the appropriate timing (e.g., after the delivery has been completed, or at periodic timing, or on a monthly basis) (S507).

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the tipping is assumed, but is not limited thereto, and for example, a virtual item may be accepted as a gift and a virtual item may appear in the content. In this situation, the value of each virtual item may be set, and if the same viewer introduces the same item multiple times, the value of the item may be increased and, the value varying unit 213 may reduce the balance of the value of all inputs over time.

In the present embodiment, the value to be subtracted is assumed to be constant, but different amounts may be reduced depending on the viewer. For example, a viewer who has purchased a particular item, or a viewer who has subscribed to a particular subscription service, may be allowed to deduct a smaller amount from the value of the gift than other viewers.

### DESCRIPTION OF REFERENCE NUMERALS

1 Viewer Terminal
2 Server
3 Provider Terminal
4 Communication Network
211 Gift Receiving Unit
212 Gift Displaying Unit
213 Value Varying Unit
214 Payment Processing Unit

1. A content distribution system comprising:
a gift receiving unit that receives gifts from multiple viewers when distributing a content;
a gift displaying unit that displays the received gift and information indicating the viewer in order of values of the gifts;
a value varying unit that varies the value of the gift;
wherein:
the gift receiving unit adds to the value of the gift when receiving additional provision of the gift.

2. The content distribution system according to claim 1, wherein:
the gift is tipping and includes an amount of money, and
the value varying unit decreases the amount of money over time.

3. The content distribution system according to claim 2, further comprising:
a payment processing unit that pays a fee to a distributor of the content in accordance with the decreased amount.

4. The content distribution unit according to claim 2, wherein:
the gift displaying unit clears the gift and the information indicating the viewer when the value no longer exists.
